(19) United States
(12) Patent Application Publication
(10) Pub. No.: US 2012/0043761 A1
(43) Pub. Date: Feb. 23, 2012

(54) APPARATUS AND METHOD TO INCREASE WIND VELOCITY IN WIND TURBINE ENERGY GENERATION

(76) Inventor: Dean White, Calgary (CA)

(21) Appl. No.: 13/148,624

(22) PCT Filed: Feb. 16, 2010
(86) PCT No.: PCT/CA10/00214

§ 371 Date: Oct. 21, 2011

(30) Foreign Application Priority Data
Feb. 17, 2009 (CA) 2654473

(51) Int. Cl. F03D 9/00; F01D 25/28

(52) U.S. Cl. 290/55; 415/213.1

(57) ABSTRACT

A wind turbine housing is provided for mounting to the roof of a building. The housing defines a Venturi pathway for collecting and accelerating wind to one or more rotors, which are coupled to one or more generators. The rotors are housed in the throat of the Venturi such that wind is accelerated to the rotors to maximize energy generation. The generators may be located within an upper chamber of the housing. The Venturi structure may be formed, in part, by the roof line of the building. A series of wind turbine housings may be mounted atop a single building and wired for use within the building, with excess power converted to AC and delivered to the associated power grid.

### FIELD OF THE INVENTION

The present invention relates generally to the use of wind energy to generate electricity. More particularly, the present invention relates to a rooftop generator with venturi design to increase wind speed and electrical power generation.

### BACKGROUND OF THE INVENTION

Modern wind turbines typically use large horizontal or vertical rotors to generate electricity. Aerodynamic modelling is used to design turbine components such as tower height, blade number, and blade shape, based on site conditions and desired electricity output. While tall wind towers with two or three large blades may provide maximal efficiency, such generators are undesirable for urban use due to the excessive tower height required to access high speed winds, and also due to excessive noise produced by the large rotors.

### SUMMARY OF THE INVENTION

The present description provides a structure for use in collecting and accelerating wind to a turbine for power generation. A conduit houses one or more rotors, which turn in response to wind flowing through the conduit. A conduit extension forms a Venturi about the conduit to accelerate wind to the conduit, maximizing rotor speed and thereby power generation.

In a first aspect, there is provided a roof-mounted venturi housing for use in directing wind to a rotor, the venturi housing comprising:
a conduit for mounting to the roof of a building, the conduit defining a first cross sectional area for housing at least one rotor; and
outwardly angled venturi surfaces extending from the conduit to form a conduit extension of enlarging cross sectional area, the conduit extension for collecting and accelerating wind to the conduit.

In an embodiment, the roof-mounted venturi housing further comprises an upper chamber above the conduit for housing one or more generators, the upper chamber continuous with the conduit to permit operative attachment of a rotor within the conduit to a generator within the upper chamber. The upper chamber may comprise an overhang surface, which may extend past the conduit extension to enhance acceleration of wind to the conduit. A portion of the overhang surface may be horizontal.

In an embodiment, one or more of the venturi surfaces forming the conduit extension is a roof surface.

In a further embodiment, the conduit extension comprises venturi surfaces that are outwardly angled by 15 to 20 degrees from the conduit walls.

In another embodiment, the conduit extension extends from the conduit to a distance at which the cross sectional area is at least two times greater than the cross sectional area of the conduit.

In another embodiment, the conduit extension extends from the conduit to a distance at which the cross sectional area is at least four times greater than the cross sectional area of the conduit.

In certain embodiments, the venturi housing further comprises a solar panel.

The housing may be of sufficient size to house a series of rotors, and/or the housing may be modular in nature such that several such housings may be adjacently mounted along a rooftop.

In a second aspect, there is provided a roof-mounted power generation system for converting wind energy to electrical power, the system comprising:
a lower chamber adapted for mounting to the roof of a building, the lower chamber comprising:
   a conduit defining a first cross sectional area, the conduit for housing at least one rotor;
   outwardly angled venturi surfaces extending from the conduit to form a conduit extension of enlarging cross sectional area, the conduit extension for collecting and accelerating wind to the conduit;
at least one wind turbine rotor mountable within the conduit to drive rotation of an axle; and
a generator for coupling to the axle to generate power upon rotation of the rotor by collected wind.

In an embodiment, the system further comprises an upper chamber attachable above the lower chamber, the upper chamber for housing the generator such that when the rotor is mounted within the conduit, the axle extends within the upper chamber for coupling to the generator.

In a third aspect, there is provided a method for generating power comprising the steps of:
providing a roof mountable venturi-like structure for collection and acceleration of wind;
mounting the venturi-like structure to a rooftop;
installing a rotor within the venturi; and
coupling the rotor to a generator such that wind-driven operation of the rotor within the Venturi will cause power to be produced at the generator.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a front vertical cross-sectional view of a roof-mounted wind generator;

FIG. 2 is a schematic drawing of wind flow through a venturi tube;

FIG. 3 is a horizontal cross-sectional view of the wind generator shown in FIG. 1;

FIG. 4a is an assembly view of a two-blade rotor;

FIG. 4b is a horizontal cross sectional view of a four-blade rotor;

FIGS. 5a and 5b are horizontal and vertical cross sectional views, respectively, of a wind generator configuration, in one embodiment;

FIG. 6a-c are horizontal, side-vertical, and front-vertical cross-sectional views, respectively, of a wind generator, in one embodiment;

FIG. 7 is a perspective view a wind generator housing with side louvers;

FIG. 8 is an assembly drawings of the rotor blade assembly, in one embodiment;

FIG. 9 is a graph comparing computer-modelled output of a four turbine generator system to that of a prior art system;

FIG. 10 is a schematic diagram of a grid-dependent power generation system in accordance with an embodiment of the invention;

FIG. 11 is a schematic diagram of the micro-generation system, indicated in FIG. 10; and

FIG. 12 is a perspective assembly view of a wind generator housing with removeable lower chamber.

### DETAILED DESCRIPTION

Generally, the present invention provides an apparatus and system for residential wind-based generation of electricity. A housing is provided for mounting of rotors and associated generators on a rooftop. The housing provides a rooftop venturi configuration for acceleration of wind through the rotors.

### Overview

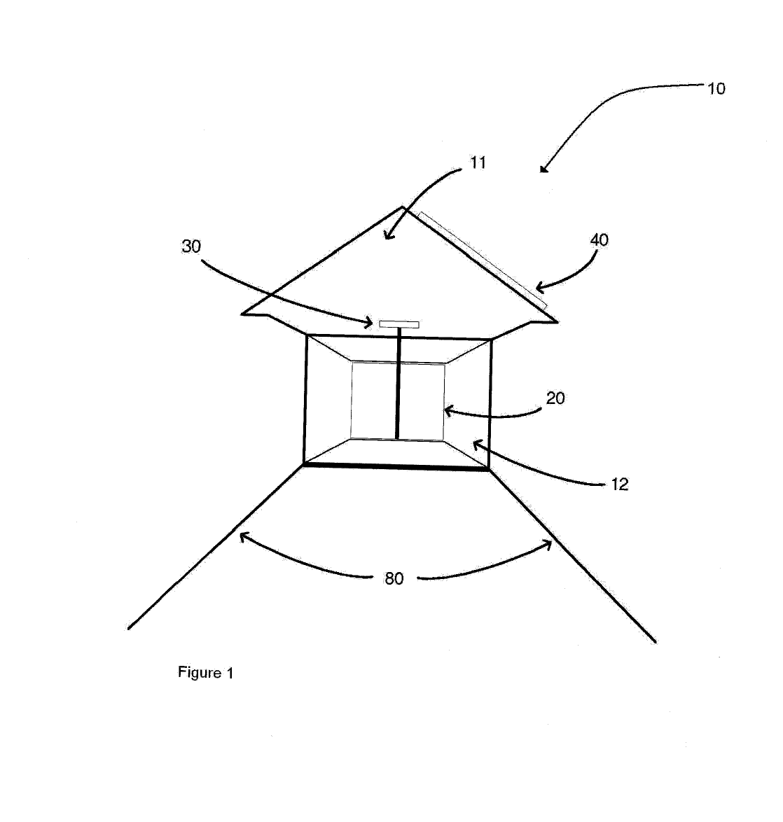

With reference to FIG. 1, a wind turbine housing 10 is shown for mounting on a rooftop 80. The housing 10 is shown in cross section to reveal the rotor 20 and generator 30. The housing generally includes an upper chamber 11 for housing the generator 30, and a lower chamber 12 for housing the rotor 20. Both the upper chamber 11 and the lower chamber 12 are configured to provide a venturi-like flow-path for accelerating wind to the rotor 20. A solar panel 40 may be placed atop the upper chamber 11 of the housing 10 for additional power generation.

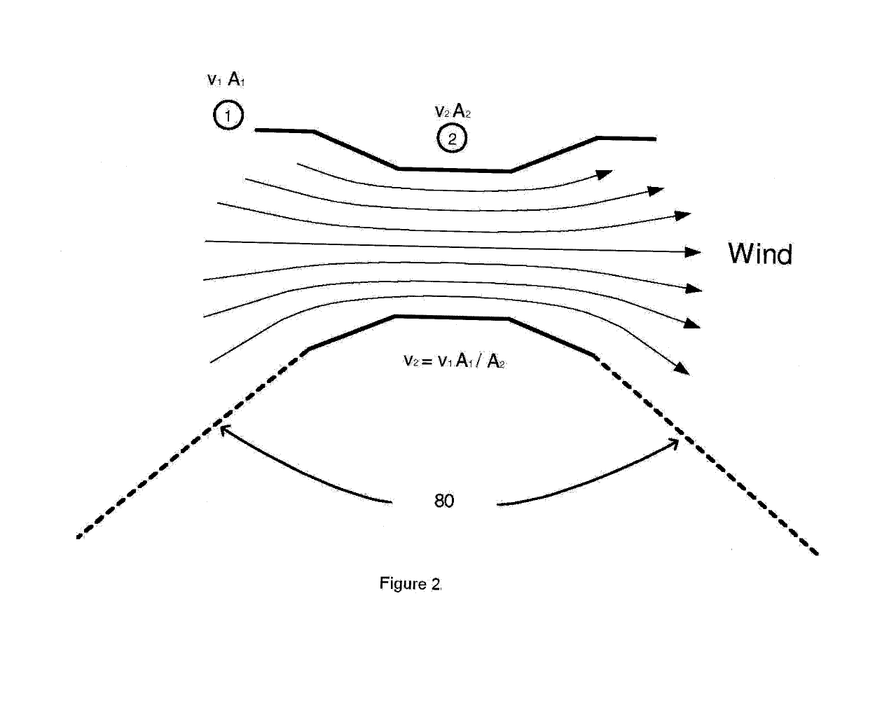

As depicted in FIG. 2, the velocity of wind flow through a Venturi at any point is dependent upon the cross sectional area of the Venturi at that location, with velocity increasing in proportion to the decrease in cross sectional area. For example, decreasing the cross sectional area from location (1) at the edge of the Venturi to location (2) at the throat of the Venturi by a factor of four, will increase the wind velocity from location (1) to (2) by a factor of four.

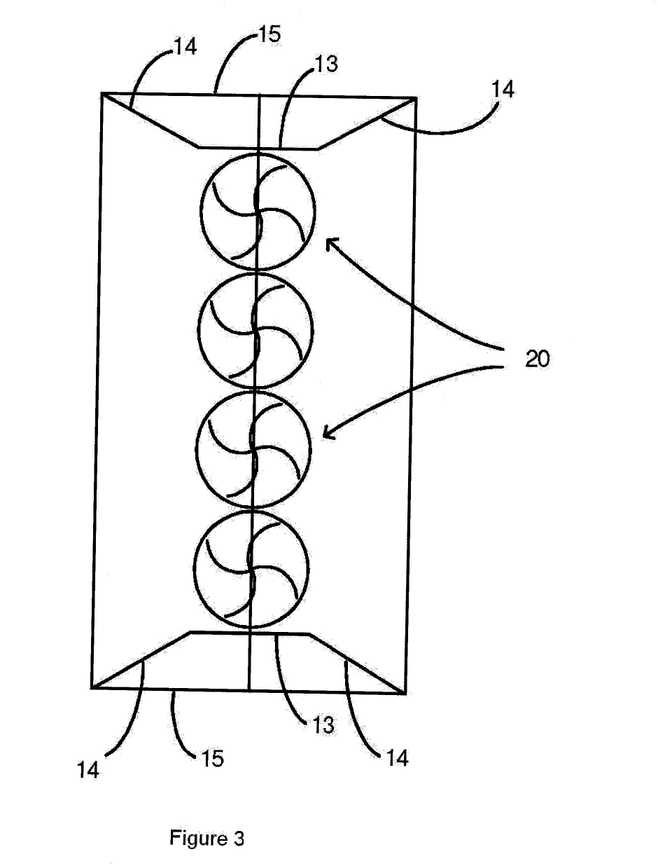

Similarly, the presently described rooftop turbine housing provides acceleration of wind through the turbine rotor(s) 20 by creating a Venturi tube-like structure between the housing 10 and roof 80. That is, the housing 10 provides an opposing sloped surface to that of the residential roof surface 80, thereby capturing and pulling wind through the vertically mounted rotor blades 20 by a Venturi effect. As shown in FIG. 3, the sides of the housing are also sloped inward towards the rotor(s) to add to the Venturi effect.

The various sloped surfaces of the housing, together with the sloped roof surface create a venturi-like flow path, with the turbine rotors located at the narrowed portion or throat of the venturi-like path. Thus, wind speed increases through the narrowed portion as the drop in pressure provides increased kinetic energy. A net force will therefore act to accelerate the air as it enters the throat of the venturi. With the cross-sectional area reduction in the throat of the Venturi tube, the air speed increases proportionally:

vₒ·Aₒ=vₜ·Aₜ

Where vₒ=venturi opening, Aₒ=venturi cross-sectional area at opening
vₜ=venturi throat, Aₜ=venturi cross-sectional area at throat

The venturi-like flowpath provided by the housing and roof surface exploits the natural flowpath of wind along the roof of a building, providing for the use of low profile vertical axis rotors as desired, eliminating the noisy and unsightly large horizontal rotor generators typically used in wind turbines. The vertical axis rotors are designed to capture the wind and force the generator to rotate with higher efficiency, and also allow wind to pass around on the return cycle of the rotation.

### Lower Chamber 12

FIG. 3 shows the lower chamber 12 of the housing 10, and rotors 20. The throat of the Venturi is defined by parallel housing side walls 13 on either side of the series of rotors 20. Sloped side walls 14 further narrow the throat, directing wind to the rotors. Outer side walls 15 define the outer dimension of the lower chamber 12 of the housing. Thus, wind passes over the roof of the building and is collected vertically between outer side walls 15. The wind is then accelerated through the rotors due to the decrease in cross sectional area provided by the sloped side walls 14 and parallel side walls 13 at the narrower throat of the Venturi.

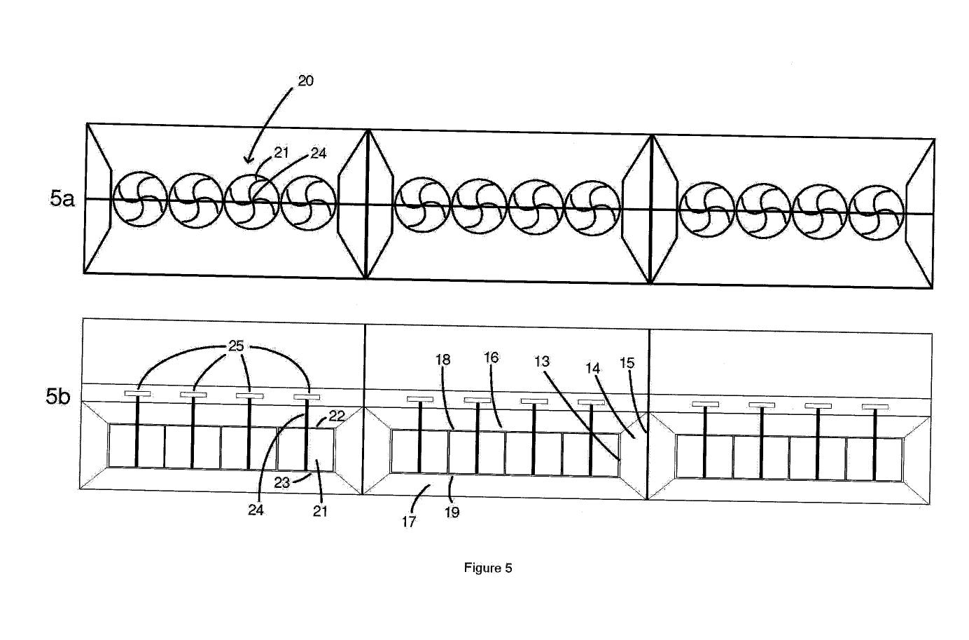

Similarly, the lower chamber of the housing is further defined by upper and lower sloped housing surfaces 16, 17, respectively (see FIG. 5b), which converge to parallel upper and lower throat walls 18, 19, respectively, above and below the rotors 20. Thus, wind passing along the roof surface 80 is collected horizontally along lower sloped housing surface 17 and accelerated towards the rotors 20. The sloped side housing walls 14, 15 and sloped upper and lower housing surfaces 16, 17 of the lower chamber 12 provide further convergence in cross sectional area at the throat. Thus, the wind pressure entering the lower chamber of the housing is converted to kinetic energy, providing a corresponding increase in the wind velocity at the throat.

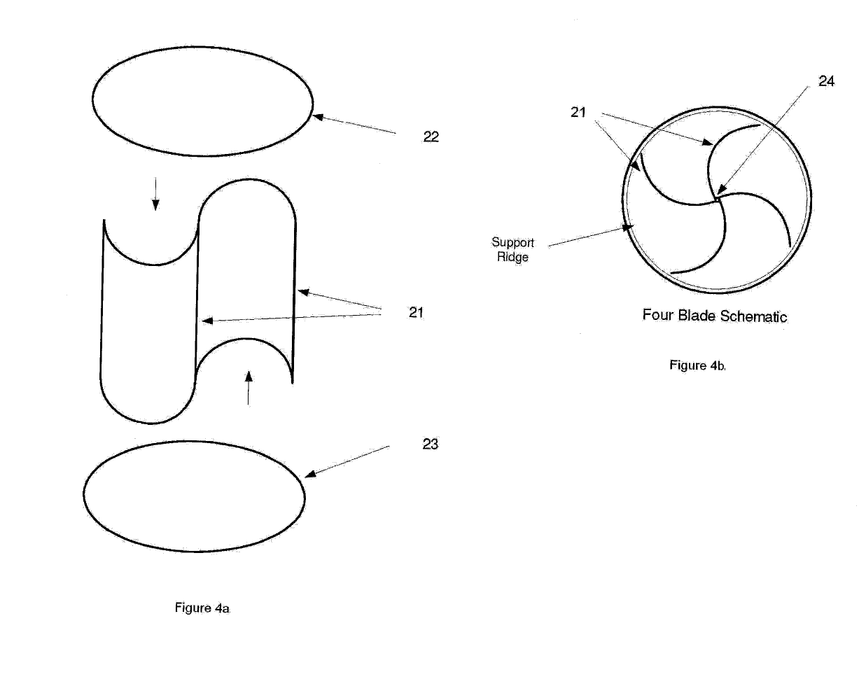

With reference to FIGS. 4a (two-blade rotor) and 4b (four-blade rotor), each rotor shown includes blades 21, mounted between a top and bottom plate 22, 23. A central axis 24 extends through each top plate for coupling to a magnetic generator 25.

The blades 21 shown are of curved or cup-shaped configuration to maximize revolutions of the axis 24 upon exposure to wind. The curved blade profile also allows the wind to pass around the blade on the return cycle of the rotation, reducing drag and further enhancing the venturi effect.

In the embodiment shown in FIG. 5, four rotors 21 are mounted in series within each housing, and each rotor is coupled to a magnetic generator 25. Such multiple rotor/generator pairs mounted in the throat of the housing will provide greater economical efficiency. Cascading several housing units along a rooftop, as shown in FIG. 5, with parallel wiring, will provide additional power if desired.

### Upper Chamber 11

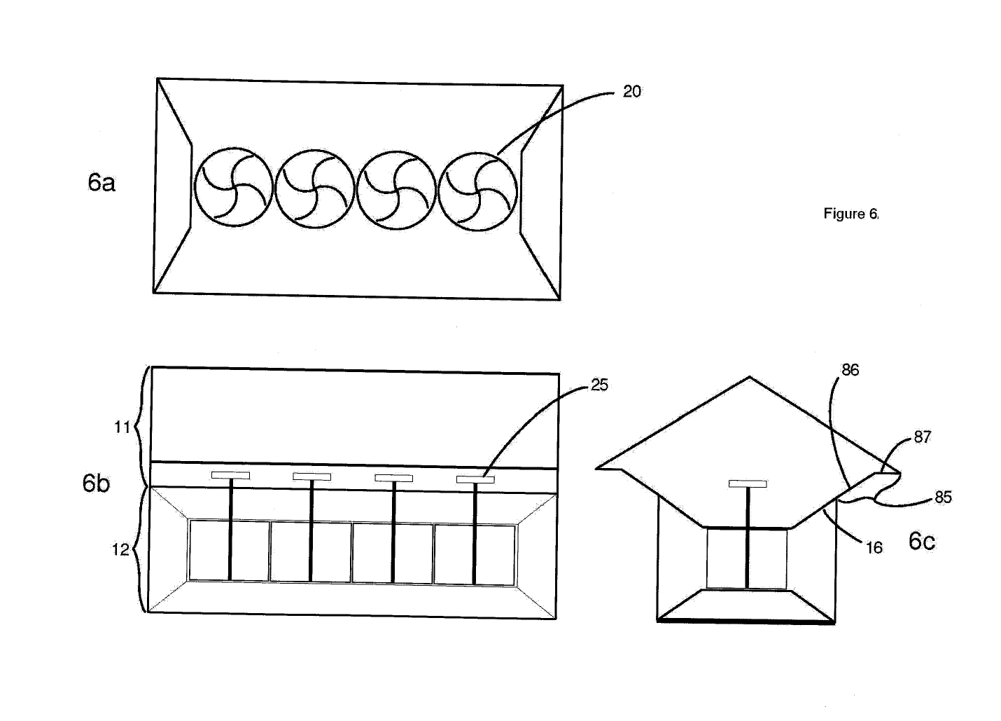

With reference to FIG. 6, the upper chamber 11 of the housing contains the generators associated with the rotors. Typically, each rotor will be coupled to one generator via the axis 24 extending from the rotor. The upper chamber 11 houses the generators, electrical circuits (including individual generator disconnect switches, bridge rectifier, fuse or circuit breaker, and grid-dependent inverter, if applicable). The inverter, if present, can be mounted in the building at the main breaker panel or within the upper chamber 11. Mounting the inverter in the upper chamber 11 provides greater efficiency by avoiding power loss associated with additional resistive wiring that would otherwise be required to reach the main breaker panel. However, if main breaker panel mounting is preferred, once the voltage has been stepped up to normal AC voltage levels (120 VAC), the lower current levels will not produce significant power losses in the electrical cable.

The electrical generators 25 may be provided as permanent magnet motors, which will minimize wear and maintenance, while providing quiet operation. In this design, the only contact will be self lubricated bearing supports that have little resistance, increasing efficiency and decreasing noise. The magnet generators mounted in the upper chamber are wired to provide high voltage with low revolutions per minute (RPM). This wiring configuration will allow the electrical generator to produce higher voltages and be more efficient even at low revolutions during low wind speeds.

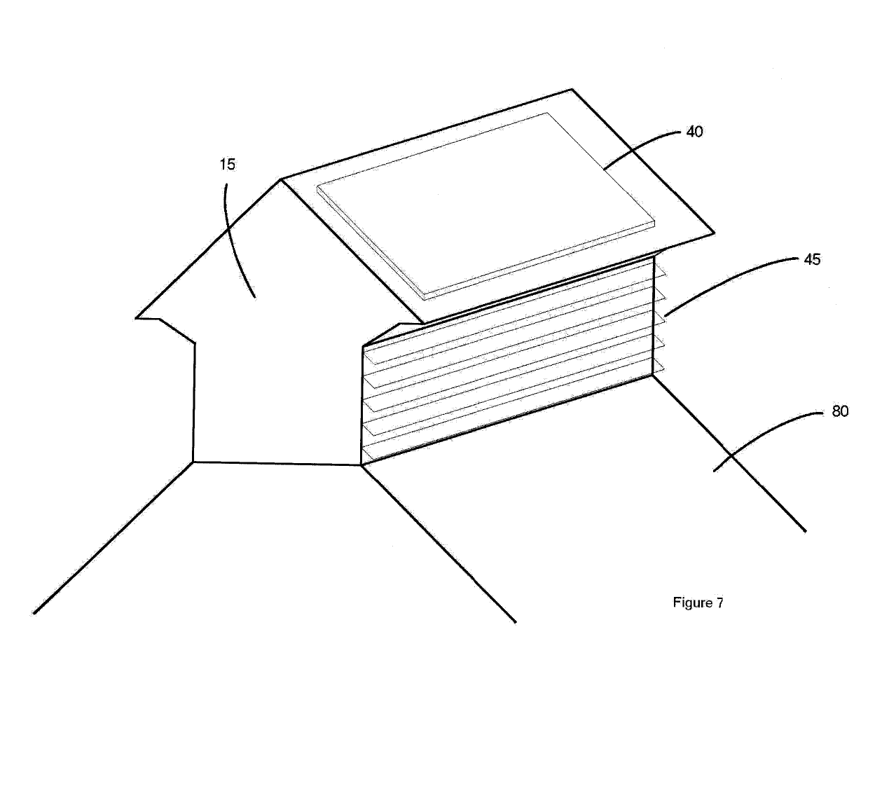

FIG. 7 provides a perspective view of the housing 10, showing outer surfaces and possible configuration when mounted to an A-frame roof. A solar panel 40 may be added to the outside surface of the outer chamber for additional energy generation. Louvers 45 may be added between the lower chamber side walls 15 to provide some control over wind intake, as well as preventing access to the housing by birds.

The upper chamber 11 of the housing 10 may be configured to improve wind collection. For example, as shown in FIG. 6c, the upper chamber 11 may include an overhang 85 that extends past the lower chamber walls and over a portion of the roof 80. The overhang may include an extension 86 of the upper sloped housing surface 16 of the lower chamber 12, and may further include a horizontal or otherwise oriented extension 87 for collecting or directing wind into the venturi. Such overhang 85 may provide an additional partial venturi effect together with the opposing roof surface 80, providing further acceleration of captured wind through the lower rotors 20.

It should be noted that the upper chamber may be of any suitable shape, as determined by functionality or appearance. For example, the top surface of the upper chamber may be rounded, squared, flattened or have a high peak depending on the surrounding roof peaks and the volume of wiring and components housed in the upper chamber. Local architectural design restrictions may apply in certain installations.

### Installation

The invention is secured to a modified A-frame roof-top and preferably uses the upwardly sloped roof surface to increase the effect of the venturi.

The angle of the sloped surfaces should be sufficient to provide the desired acceleration of wind. Preferably, the angle of the sloped surfaces are between 15 and 20 degrees from horizontal. In computer modelling conducted to date, it appears that an angle of 17.5 degrees towards the throat is suitable. These angles are suitable regardless of the roof pitch, but may be optimized by custom design, based on site conditions.

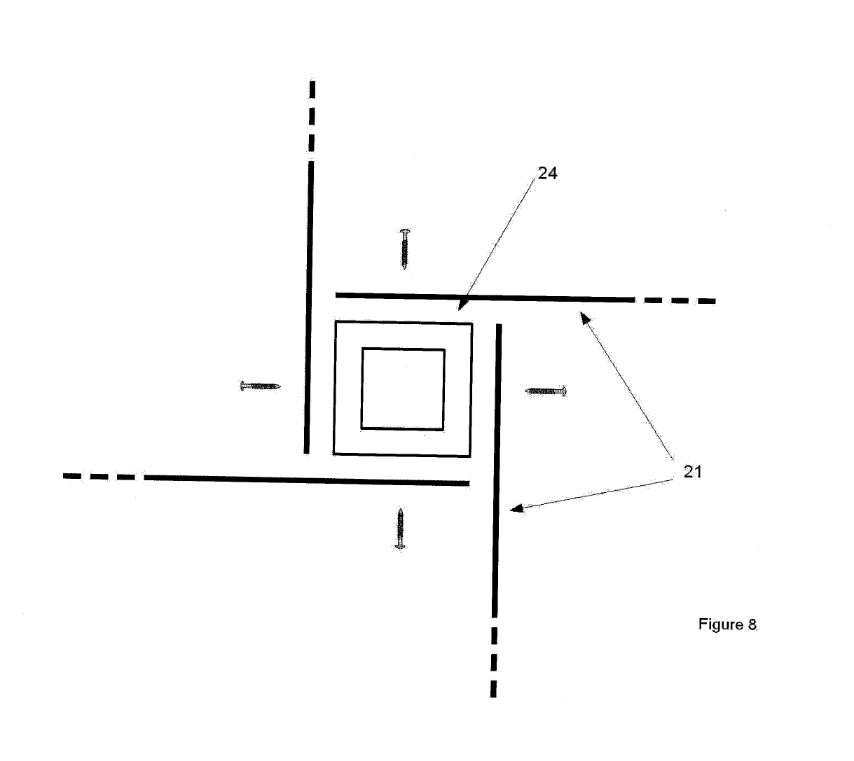

With respect to FIG. 8, the blades (only partially shown, with dashed lines indicating extending rotor blades) may be mounted to an axis 24′ to form the rotor 20′. The axis extends from the rotor to couple with the generator 30 above the venturi housing.

A grid dependent inverter may be provided to convert the DC power to AC power with proper voltage levels and frequency and allow connectivity to the utility grid. A disconnect switch and fuse or circuit breaker may be provided as a safety feature.

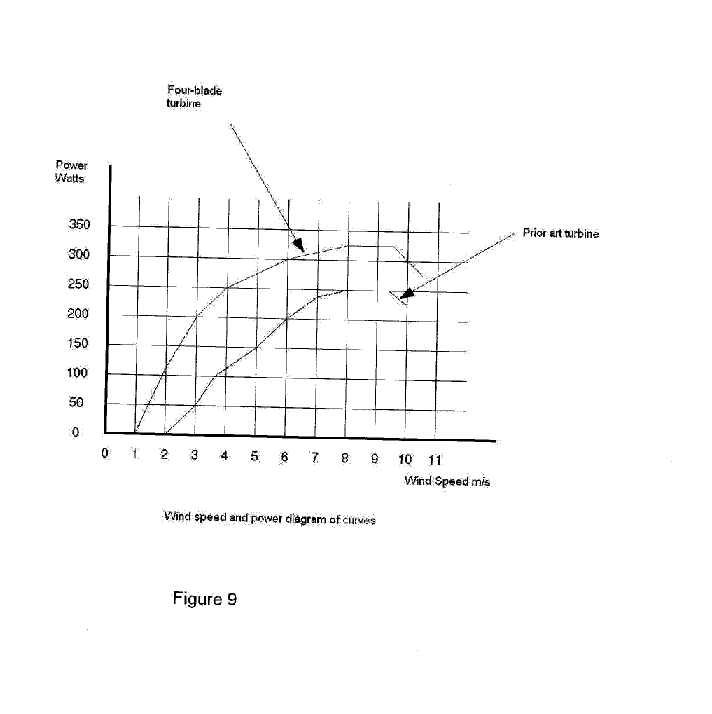

A single line diagram for a grid-dependent micro-generation system is illustrated in FIG. 9 by way of hypothetical example only. This system uses a two-way power meter to measure the amount of power being used/generated in a home or small office and connects to a breaker on the main breaker panel. It is estimated that, using an average wind speed of 4.1 m/s in Alberta and assuming a fourfold increase in wind speed based on appropriate design of the housing (fourfold reduction of cross sectional area to the throat), an average of 250 watts of power may be generated per turbine. With four turbines per housing, this translates to an average of 1000 watts of output. The four-blade rotor system exemplified in the graph of FIG. 9 converts wind energy to power at very low wind speeds and will produce more power output over a given range of wind speeds. It is therefore believed that improvements in efficiency will be realized over the systems of the prior art.

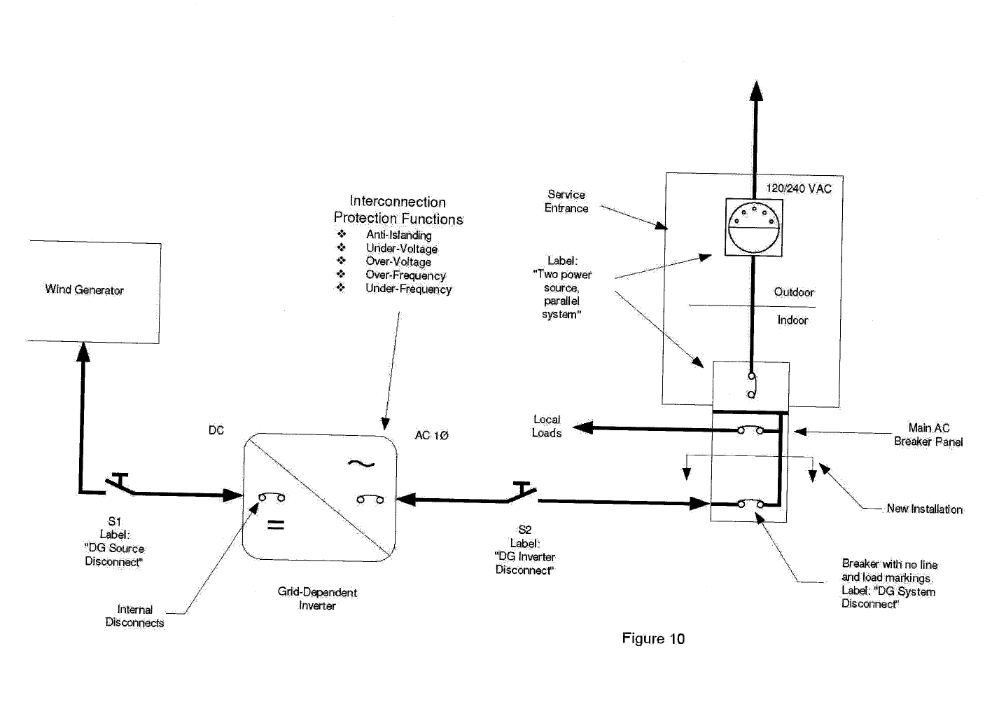

A line diagram for a grid-dependent micro-generation system is shown in FIG. 10 by way of example only.

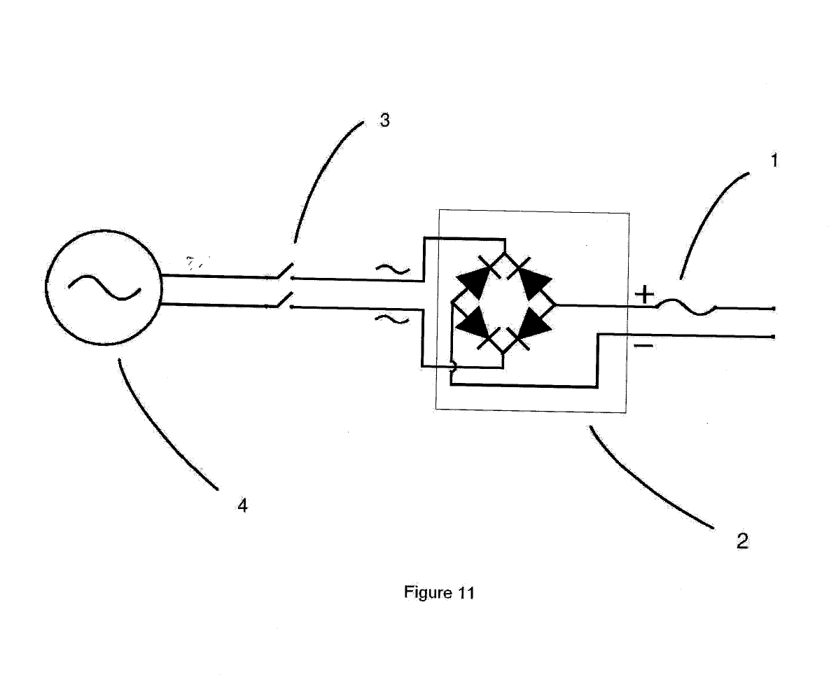

One possible electrical connection for the roof-top generator is shown in FIG. 11 with a disconnect switch, rectifier and fuse/breaker. A permanent magnet generator 4 converts mechanical energy into electric energy. An AC power output is connected to the circuit using a shunt switch, 3. A shunt resistor (not shown) may be added to allow the switch to connect the generator to the resistor, which would convert the electrical power into heat by putting a load on the generator, effectively braking the generator. This shunt resistor could be used to brake the generator for maintenance of the unit, or load the generator during high winds. A bridge rectifier 2 converts the AC electrical power to DC power, and a safety fuse 1 provides added security in case of an excessive current draw.

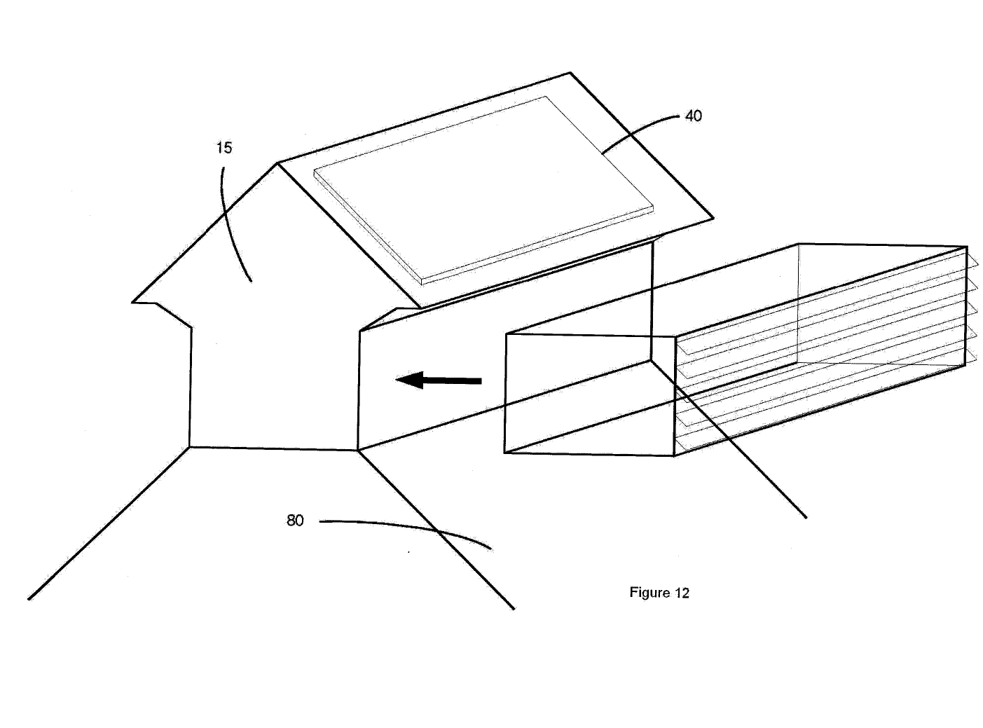

With reference to FIG. 12, the venturi housing can be built/installed in two stages. For example, the home-builder can build the exterior housing, including upper chamber 11 and exterior side walls 15, as per required design specifications and to meet local building codes and any architectural restrictions. The lower chamber may be independently manufactured for insertion into the housing, with assembly and final wiring conducted on-site.

During maintenance, the louvers can be closed to slow the wind collection as desired, for example during maintenance. Further, as mentioned above, shunt load can be connected to the generators and activated to slow the rotors, during maintenance or in high wind conditions. The shunt load would pull more current from the generator, which then requires more torque to turn, thereby slowing the rotors.

In some instances, a three blade design may be suitable to dampen vibrations and noises in certain applications.

Various generators can be used within the chamber, ie. 100 Watt, 200 Watt, 500 Watt, etc. The higher wattage can be used in areas where the wind velocity is typically high, and the system is therefore much more efficient. To illustrate this, FIG. 9 shows that the generator may become inefficient beyond 2½ times the average local wind speed of 4.1 m/s.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A roof-mounted venturi housing for use in directing wind to a rotor, the venturi housing comprising:
a conduit for mounting to the roof of a building, the conduit defining a first cross sectional area for housing at least one rotor; and
outwardly angled venturi surfaces extending from the conduit to form a conduit extension of enlarging cross sectional area, the conduit extension for collecting and accelerating wind to the conduit.

2. The roof-mounted venturi housing as in claim 1, further comprising an upper chamber above the conduit for housing one or more generators, the upper chamber continuous with the conduit to permit operative attachment of a rotor within the conduit to a generator within the upper chamber.

3. The roof-mounted venturi housing as in claim 2, wherein the upper chamber comprises an overhang surface, the overhang surface extending past the conduit extension to enhance acceleration of wind to the conduit.

4. The roof-mounted venturi housing as in claim 3, wherein a portion of the overhang surface is horizontal.

5. The roof-mounted venturi housing as in claim 1, wherein one or more of the venturi surfaces forming the conduit extension is a roof surface.

6. The roof-mounted venturi housing as in claim 1, wherein the conduit extension comprises venturi surfaces that are outwardly angled by 15 to 20 degrees from the conduit walls.

7. The roof-mounted venturi housing as in claim 1, wherein the conduit extension extends from the conduit to a distance at which the cross sectional area is at least two times greater than the cross sectional area of the conduit.

8. The roof-mounted venturi housing as in claim 1, wherein the conduit extension extends from the conduit to a distance at which the cross sectional area is at least four times greater than the cross sectional area of the conduit.

9. The roof-mounted venturi housing as in claim 1, further comprising a solar panel.

10. The roof-mounted venturi housing as in claim 1, wherein the conduit is of sufficient size to house a series of rotors.

11. The roof-mounted venturi housing as in claim 1, wherein the housing is of a modular nature such that several such housings may be adjacently mounted along a rooftop.

12. A roof-mounted power generation system for converting wind energy to electrical power, the system comprising:
a lower chamber adapted for mounting to the roof of a building, the lower chamber comprising:
a conduit defining a first cross sectional area, the conduit for housing at least one rotor;
outwardly angled venturi surfaces extending from the conduit to form a conduit extension of enlarging cross sectional area, the conduit extension for collecting and accelerating wind to the conduit;
at least one wind turbine rotor mountable within the conduit to drive rotation of an axle; and
a generator for coupling to the axle to generate power upon rotation of the rotor by collected wind.

13. The roof-mounted power generation system as in claim 12, further comprising:
an upper chamber attachable above the lower chamber, the upper chamber for housing the generator such that when the rotor is mounted within the conduit, the axle extends within the upper chamber for coupling to the generator.

14. A method for generating power comprising the steps of:
providing a roof mountable venturi-like structure for collection and acceleration of wind;
mounting the venturi-like structure to a rooftop;
installing a rotor within the venturi; and
coupling the rotor to a generator such that wind-driven operation of the rotor within the Venturi will cause power to be produced at the generator.
